(19) United States
(12) Patent Application Publication
(10) Pub. No.: US 2017/0144831 A1
(43) Pub. Date: May 25, 2017

(54) FIBER DELIVERY SYSTEM

(71) Applicant: SCHLUMBERGER TECHNOLOGY CORPORATION, Sugar Land, TX (US)

(72) Inventors: Kim A. Hodgson, Sugar Land, TX (US); Hau Nguyen-Phuc Pham, Houston, TX (US); Larry Welch, Missouri City, TX (US)

(21) Appl. No.: 14/947,185

(22) Filed: Nov. 20, 2015

(51) Int. Cl. B65D 88/54; B65G 11/02; E21B 33/13; B65G 15/00; B65G 19/00; E21B 43/26; B65G 33/14; B65G 27/00

(52) U.S. Cl. CPC B65D 88/54; B65G 33/14; B65G 11/026; B65G 27/00; B65G 15/00; B65G 19/00; E21B 43/26; E21B 33/13

(57) ABSTRACT

A system for managing fiber on-site at an oilfield. The system includes a packing region and a corresponding region which both interface a bulk of the fiber simultaneously. However, the packing region is of a moving character and the corresponding region is of a substantially different character which may or may not be static in nature. Regardless, the difference in character between the adjacent regions allows for a substantially continuous manner of packing fiber. This may be particularly beneficial where the fiber is of a crimped nature or otherwise comparatively light or of low density as may be the case for certain downhole fracturing or cementing applications utilizing the fiber at the oilfield.

### BACKGROUND

Exploring, drilling and completing hydrocarbon and other wells are generally complicated, time consuming, and ultimately very expensive endeavors. As a result, over the years, a significant amount of added emphasis has been placed on overall well architecture, monitoring and follow-on interventional maintenance. Careful attention to the cost effective and reliable execution of completing such wells and carrying out such applications may help maximize production and extend well life. Thus, a substantial return on the investment in the completed well may be better ensured.

In line with the objectives of maximizing cost effectiveness and overall production, the well may be fairly sophisticated in terms of architecture. For example, the well may be tens of thousands of feet deep, traversing various formation layers, and utilize strategically located perforations into the adjacent formation layers. That is, in order to promote hydrocarbon production from such locations, tunnel-type fractures in the form of perforations may be provided that emerge from the wellbore as noted.

In addition to the application for forming the perforations, a fracturing application may also take place. More specifically, a fracturing fluid or slurry may be pumped at high pressure into the well. This slurry may include a proppant to enhance the characteristics of the perforations. The proppant is a solid particulate, often sand, which may serve to help fortify the perforations and keep them propped open.

Unfortunately, in certain circumstances, the proppant may fail to remain in place. That is, as a fracturing application concludes and fracturing fluid flows back into the wellbore from the perforations, the proppant may also return from the perforations in what is generally referred to as “flowback”. Thus, in order to help avoid flowback of proppant, slurries have been developed that utilize flowback inhibiting fibers. These fibers may range from about 10 to about 100 mesh and be of a natural or synthetic glass, ceramic or even metal. Regardless, the incorporation of such fibers into the fracturing slurry may substantially prevent flowback of proppant into the wellbore. Specifically, after being added to the slurry, the fibers may display a web-like character that acts to trap particulate in the perforation to substantially prevent flowback. Of course, adding fibers such as these to a slurry may be beneficial in other applications beyond fracturing. For example, cement slurries and other well treatment fluids may benefit from incorporating such fiber materials.

It is of note that the fibers are not of great benefit if added too far in advance of the use of the slurry in a downhole application as described. That is, due to the web-like character that emerges some short time after being added to the slurry, it is not generally beneficial to add the fibers prior to use of the slurry at the oilfield. Instead, to prevent premature clogging due to the developing web-like character of the fibers, they may be added to the slurry at or near the time of slurry use downhole. For example, a chopper in the form of a manual handheld gun-type of tool may be utilized by an operator to deliver fiber to a mixing slurry at the oilfield surface just prior to use in a fracturing application.

Alternatively, a higher rate of fiber addition to the slurry mix may be sought than what is available from such a manual tool. In these circumstances, a higher rate of delivery may be obtained from a hopper-fed delivery system that operates in a more automated fashion. For example, a hopper with tapered sidewalls may lead to a screw-auger type of metering device therebelow. Thus, in theory, the metering device may advance a measured amount of fiber to the slurry at a higher rate than otherwise manually attainable.

Unfortunately, the described type of metering system is often lacking in accuracy. For example, the amount of fiber added to the slurry for a fracturing application via the system may be upwards of 20% more or less than the amount of fiber sought for mixing into the slurry. Once more, as described below, in addition to the dramatic variability in the amount of fiber that may or may not be mixed into the slurry, there may be substantial difficulty in effectively adding the fiber to the slurry at all.

Recent developments in fiber materials, processing and handling have led to the option of utilizing fibers that display unique characteristics, for example, tailored to further enhancing flowback reduction as described above. This may include the use of shorter fibers that are crimped or kinked in advance of incorporation into the fracturing slurry. For the performance of the fracturing application this may enhance the reliability of the web-like character for reducing flowback.

Unfortunately, from the standpoint of transporting, handling and delivering the fibers this may translate into a fiber material that is added to the hopper or delivery system in a less dense and “puffier” manner. As a result, the addition of the fibers may now be more like putting cotton candy into the hopper as opposed to a heavier and more easily meter-able material. In fact, in many circumstances, a hopper-type metering system as described may be unable to effectively deliver such fiber material to the slurry to any effective degree at all. Therefore, as a practical matter, in many circumstances, operators are left with the only practical options being the use of a less effective fiber material choice or a less than desired rate of fiber addition to the slurry via manual chopper techniques as detailed above.

### SUMMARY

A fiber delivery system is provided with a packing region and a corresponding region. The packing region includes a moving character to interface fiber material to actively promote advancement thereof toward a metering location. The corresponding region is located adjacent the packing region to also interface the fiber material. However, the corresponding region includes a character that is substantially different from the moving character of the packing region.

### BRIEF DESCRIPTION OF THE DRAWINGS

FIG. 1 is a partially sectional, side schematic view of an embodiment of a fiber delivery system for a slurry supporting an application in a well.

FIG. 2A is an enlarged view of a perforation into a formation adjacent a well and receiving a slurry formed in part by the fiber delivery system of FIG. 1.

FIG. 2B is an enlarged view of the perforation of FIG. 2A with fibers of the slurry forming a web-like matrix therein to mitigate flowback into the well.

FIG. 3 is an overview depiction of the fiber delivery system and associated equipment at an oilfield accommodating the well and perforation of FIGS. 2A and 2B.

FIG. 4 is a partially sectional side view of another embodiment of a fiber delivery system for a well application slurry.

FIG. 5 is a flow-chart summarizing an embodiment of developing and utilizing a well application slurry with the assistance of a fiber delivery system.

### DETAILED DESCRIPTION

In the following description, numerous details are set forth to provide an understanding of the present disclosure. However, it will be understood by those skilled in the art that the embodiments described may be practiced without these particular details. Further, numerous variations or modifications may be employed which remain contemplated by the embodiments as specifically described.

Embodiments herein are described with reference to certain downhole stimulating applications. Specifically, a fracturing fluid or slurry is developed at an oilfield surface and utilized to enhance the character of fractures or perforations in a well. However, a variety of alternate slurries and applications may take advantage of embodiments of a fiber delivery system used to help develop such slurries as detailed herein. For example, cementing slurries and applications may benefit from the unique fiber delivery systems and techniques as detailed herein. Regardless, so long as the fiber delivery system utilizes a packing region with a moving character adjacent a corresponding region with a character substantially different from the moving character in managing the fiber, appreciable benefit may be realized.

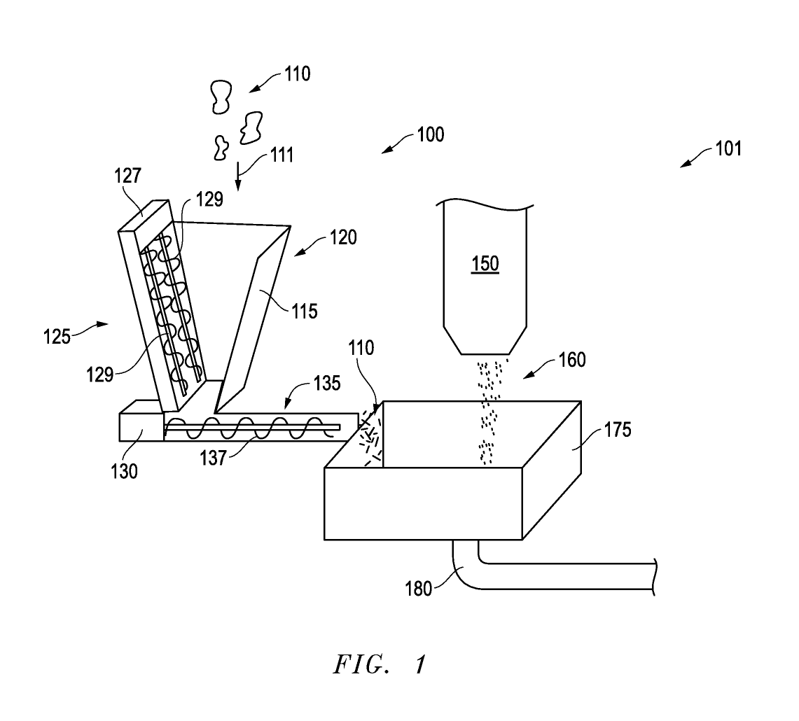

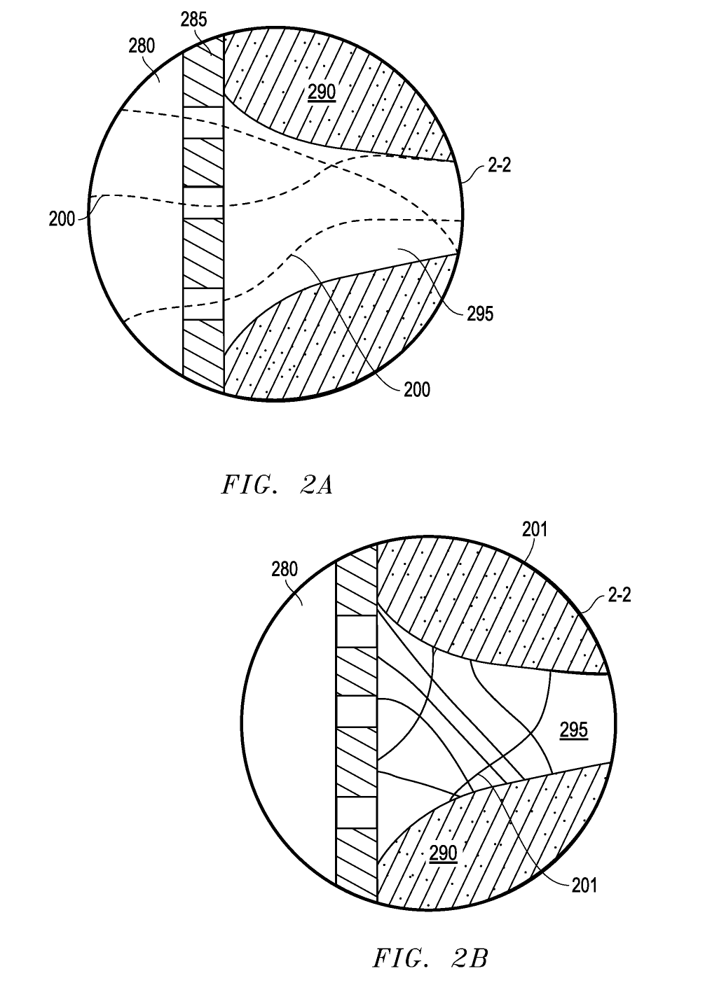

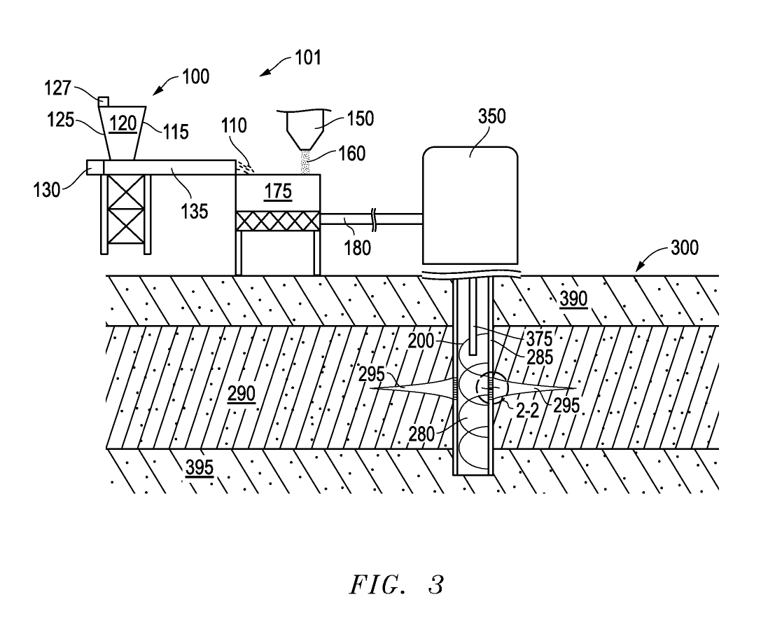

Referring now to FIG. 1, a partially sectional, side schematic view of an embodiment of a fiber delivery system 100 is shown. With added reference to FIGS. 2 and 3, the system 100 is part of an overall fiber management assembly 101 that is configured to help develop a slurry 200 on site at an oilfield 300, for an application in a well 280. For example, the assembly 101 may include a feeder 150 for delivery of an application mix 160, perhaps proppant-based, to a mixer 175. Similarly the delivery system 100 may be used to deliver a fiber 110 to the mixer 175. Thus, ultimately, the mixer 175 may be utilized to blend and develop a slurry 200 that may be advanced through a delivery line 180 and to a well head 350 for eventual use in a downhole fracturing application (again see FIGS. 2 and 3).

In the embodiment shown, as delivered to the mixer 175, the proppant-based mix 160 may be a water or other liquid with a proppant such as sand, ceramic material, bauxite, and/or a variety of other abrasive additives blended therein. However, unlike these constituents which may be pre-blended to a degree before reaching the mixer 175, it may be desirable to add fiber 110 on-site, just prior to an oilfield application. This is in part due to the tendency of the fiber 110 to exhibit a degree of flow-inhibiting characteristics over time. Thus, by adding the fiber 110 immediately preceding the application, delivery of the slurry 200 from the mixer 175 to a downhole application site may be less of a challenge (see FIG. 2).

Flow-inhibiting characteristics of the fiber 110 may be beneficial to downhole fracturing or cementing applications, though other applications may also make use of such types of fiber 110. In the embodiments depicted herein, the fibers 110 may be delivered to the worksite as a crimped and light, 15-25 lb. per cubic foot, fluffy, 10-100 mesh of natural or synthetic material. The material may be glass, ceramic, metal or others. Regardless, delivery of a reliably consistent, metered amount of the fiber 110 to the mixer 175 may be substantially assured by use of the delivery system 100 shown. More specifically, the fluffy, low-density nature of the fiber 110, due to its crimped character, as shown entering the system 100 (see arrow 111) may be transformed into a packed workable, higher density form which exits the system 100 to the mixer 175. As a result, even though the fiber 110 may be delivered to the worksite in a difficult-to-manage form, the system 100 may ultimately deliver a reliably controlled and metered amount thereof to the mixer 175 as detailed here below.

Continuing with reference to FIG. 1, the fiber delivery system 100 of the assembly 101 includes a hopper 120 that terminates at a metering mechanism 135. The hopper 120 includes a packing region 125 adjacent a corresponding region 115 which both interface fiber 110 as it is fed into the system 100. More specifically, a sufficient amount and rate of fiber 110 may be fed into the hopper 120 resulting in both regions 125, 115 making contact with a bulk fiber 110, simultaneously. Indeed, for a conventional fracturing operation slurry, a steady rate of about 10 to about 300 pounds per minute of fiber 110 may be fed into the hopper 120 whereas the rate may be 5-20 pounds per minute for developing a cement slurry. In either case, the packing region 125 may include a moving character that forcibly packs and advances the bulk fiber 110 toward the location of the metering mechanism 135 below.

In the embodiment shown, a moving character of between about 20-40 pounds of force is provided by multiple augers 129 of the packing region 125 so as to provide a shearing form of fiber packing. However, in other embodiments, the moving character may be provided by a conveyor belt, drag chain or other suitable advancable feature at a variety of different levels of force.

In contrast to the packing region 125, the corresponding region 115 which simultaneously interfaces the same bulk of downwardly moving fiber 110 does not share an identical moving character as that of the packing region 125. Indeed, the character of the corresponding region 115 is substantially different than that of the moving character. For example, in the embodiment shown, the corresponding region 115 is a static sidewall of the hopper 120. Though, as detailed further below, the substantially different character of the corresponding region 115 need not necessarily be a static character. Regardless, the character of the corresponding region 115 provides an advantage in being substantially different from the moving character of the packing region 125. Specifically, two adjacent regions 115, 125, simultaneously acting on the same bulk of fiber 110 within the hopper 120 in a nearly identical fashion would tend to forcibly pack the fiber 110. However, this might also tend to pack the fiber 110 into a stable and largely immobile mass stuck just above the metering mechanism 135 in a “bridging” or bottlenecking fashion. This may be particularly the case where the regions 115, 125 are directly opposite one another, allowing the immobile mass to form a stable arch of fiber at the bottom of the hopper 120.

In order to avoid such bottlenecking circumstances, the packing region 125 is not structurally paralleled by a corresponding region 115 that may be substantially different in any number of respects so as to avoid such bottlenecking of fiber 110. For example, in the embodiment where the packing region 125 is made up of multiple rotating augers 129 for packing as shown, the corresponding region 115 may be static as indicated above.

Alternatively the corresponding region 115 may have a moving character that is of a vibrating-type, conveyor belt-type, or drag chain type. Indeed, this region 115 may include a moving character that is even auger-type with one or more augers. However, in this circumstance, the corresponding region 115 would still be of a substantially different character than that of the packing region 125. For example, in such an embodiment, the auger(s) of the corresponding region 115 may move at a substantially different rate from the augers 129 of the packing region 129 or be offset from, as opposed to directly opposite and mirroring, these other augers 129. Thus, the character of the corresponding region 115 would remain substantially different from the moving character of the packing region 125 so as to prevent bottlenecking. In an embodiment, the corresponding region 115 may include a passive belt, passive auger or other type of “moving” but with a character that is nevertheless substantially different from the active moving character of the packing region 125. In this embodiment, the movement of the corresponding region 115 would actually be driven or powered by the packing region 125 as translated through the fibers 110 as they are packed. This may provide a degree of stability to the operating system 100 while still avoiding bottlenecking of fiber 110 at the bottom of the hopper 120 as described above.

As shown in FIG. 1, and described above, a workable packing of the fiber 110 is achieved at the regions 125, 115 whereas metering is subsequently achieved by the metering mechanism 135. In the embodiment shown, the metering mechanism is a metering auger 137 configured for advancing a given weight of packed fiber 110 per revolution. This auger 137 is located in a channel leading to the mixer 175 for fiber delivery thereto. However, other forms of volume metering devices may be utilized. Further, packing 127 and metering 130 control units may be utilized to power and control the rate of packing and metering of the fiber 110. Of course, the choice of pitch and other auger characteristics may also help control the packing and metering rates where augers are used for the indicated packing and metering.

In an embodiment, the packing control unit 127 includes a hydraulic motor and sensors to monitor a real-time rate of fiber packing. The metering control unit 130 may also be outfitted with a hydraulic motor and a capacity to adjust speed based on the actual rate of fiber packing taking place thereabove. For example, adjustments to the speed of the metering auger 137 may be made based on information from the packing control unit sensors, sensors of the metering control unit 130 or operator based adjustment. Regardless, a reliably consistent metering of the fiber 110 to the mixer 175 may be attained.

Referring now to FIGS. 2A and 2B, with added reference to FIG. 1, enlarged views of a perforation 295 through casing 285 and into a formation 290 adjacent a well 280 are shown. More specifically, FIG. 2A depicts the perforation 295 during a fracturing application, as a slurry 200 is received therein which has been formed in part by the fiber delivery system 100. FIG. 2B, on the other hand reveals the same perforation 295 after fracturing, once fluids move out, leaving behind a web-like matrix 201 formed by the fibers 110. This matrix 201 may help prevent flowback of proppant and other materials, thereby enhancing the structural integrity of the perforation 295.

With the perforation 295 more reliably intact, hydrocarbon flow into the well 280 may be enhanced. At the same time, however, the avoidance of flowback may also help to minimize the production of abrasive components, geologic particulate and other material that tends to wear on oilfield equipment.

Referring now to FIG. 3, an overview depiction of the fiber delivery system 100 is shown at an oilfield 300 that accommodates the well 280 and perforations 295 of FIGS. 2A and 2B. In this view, an overall perspective of how the fiber 110 of FIG. 110 is reliably managed into a slurry 200 and utilized in a well 280 is visibly apparent. This is achieved through the use of oilfield equipment that includes a wellhead 350 adjacent a fiber management assembly 101 with a fiber delivery system 100 as detailed above.

In the embodiment shown, the well 280 traverses various formation layers 390, 290, 395 with perforations 295 reaching into one such layer 290 for sake of production. Thus, hydrocarbons may be taken up through a production tubular 375 and distributed from the wellhead 350 for further management. However, in order to enhance such production, a fracturing application utilizing a slurry 200 directed at the perforations 295 may first be undertaken. This may include injecting the slurry 200 at high pressure into the well 280. As shown, in FIG. 3, fluid streams of slurry 200 are depicted that are able to penetrate the well formation 290 into the prior formed perforations 295. Thus, the enlarging of these perforations 295 or fractures takes place, thereby encouraging the targeted uptake of hydrocarbons from the formation 290 and into the well 280.

In order to ensure that the slurry 200 is of a properly tailored predetermined mix of proppant mixture 160 and fiber 110, the fiber delivery system 100 as detailed above is utilized. More specifically, a hopper 120 may be filled and maintained to a relatively constant level of un-packed, crimped and comparatively low density fiber 110 as the system 100 is operated. Ultimately, through control units 127, 130 coupled to a packing region 125 and a metering mechanism 135 respectively, a reliably metered rate of packed fiber 110 may be delivered to the mixer 175. Thus, the fiber 110 may be combined with the proppant based mix 160 from the feeder 150 and advanced through the delivery line 180 to the wellhead 350 for the fracturing application as described above. Notably, with the fiber 110 added on-site in this manner, the slurry 200 may retain workable flow properties for the fracturing application, while still later allowing the fiber 110 to take on a web-like matrix 201 as shown in FIG. 2B.

In an embodiment, the fiber delivery system 100 may be located elsewhere, perhaps more remote from the mixer 175, for example where the oilfield equipment includes a larger scale solids delivery unit with a vortex blender to serve as the mixer. Nevertheless, the system 100 may be modified to allow for use with such equipment. For example, the metering mechanism 135 may be extended to any practical linear length for reaching a more remote mixer 175. Alternatively, once metering has taken place, the metering mechanism 135 may interface a separate delivery mechanism, not necessarily constrained to a linear configuration, for advancement to the mixer 175.

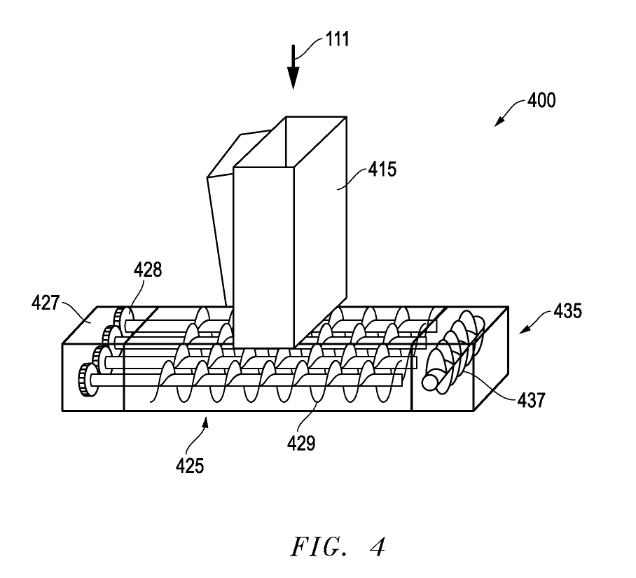

In addition to modifying the configuration of the system 100 in terms of the metering mechanism 135, the system 100 may also be modified in terms of the location and orientation of the packing region 125. For example, with specific reference to FIG. 4, a partially sectional side view of an embodiment of a fiber delivery system 400 is shown where the packing region 425 is not incorporated into a sidewall of the hopper 415. Instead, the packing region 425 includes a packing auger 429 located below the hopper 415.

In the embodiment of FIG. 4, the hopper 420 may be filled with light fiber from the top (see arrow 111). In this embodiment, the hopper is substantially straight and non-tapered to help avoid bottlenecking of fiber before reaching the packing region 425. Once reaching this region 425 a host of packing augers 429 may be utilized for packing the fiber similar to the technique detailed above with respect to FIG. 1. In this view, individual drives 428 of the control unit 427 are apparent for rotating each of the augers 429 at a predetermined rate of packing. Similar to the embodiment of FIG. 1, as the fiber is packed it is advanced toward a metering location. However, in the embodiment of FIG. 4, the metering location or mechanism 435 is located adjacent, as opposed to below, the packing region 425. Nevertheless, as with the embodiment of FIG. 1, a metering auger 437 of the mechanism 435 may be utilized for metering and/or eventual delivery of fiber to a mixer at an oilfield for a downhole application.

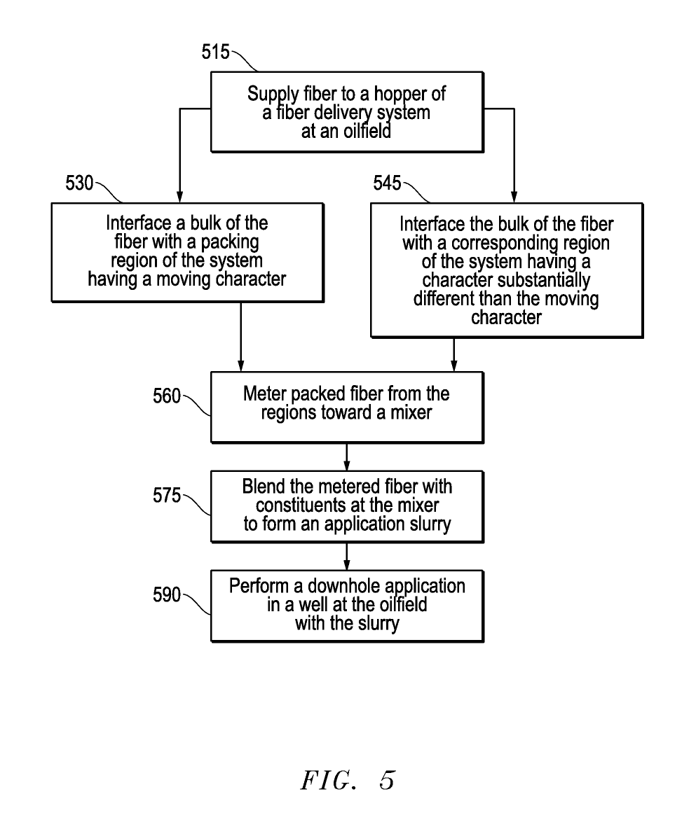

Referring now to FIG. 5, a flow-chart summarizing an embodiment of developing and utilizing a well application slurry with the assistance of a fiber delivery system. As indicated at 515, a supply of fiber may be provided to the system at a fairly consistent rate, for example, via a conventional hopper. The fiber may then be packed by simultaneously interfacing a packing region with one moving character (see 530) and a corresponding region with a character that is substantially different than the moving character (545). This may be particularly beneficial for packing a fiber that is fluffy, light or of a natural bulk that is comparatively low in density. Specifically, the simultaneous interfacing with each of the packing and corresponding regions allows for packing of the fiber into a more workable form while doing so in a fashion that avoids bottlenecking-type of issues that might result if each region included substantially the same moving character.

Once packed, the more workable fiber form may be metered as indicated at 560 and advanced toward a mixer. The packed and metered fiber may reach the mixer at a fairly consistent and reliable predetermined rate due to the enhanced workability provided. Therefore, as indicated at 575, the fiber may be mixed with other constituents, for example to form a fracturing or cement slurry which may be available for near immediate use in a downhole application (see 590).

Embodiments described hereinabove include a fiber delivery system and techniques that allow for the incorporation of less dense or puffier fiber types into downhole application slurries in a reliable manner. That is, system embodiments disclosed herein allow for the addition of such fibers to a mixer at a predetermined reliable rate in spite of the unique workability challenges associated with such fiber materials. As a practical matter, this means that operators are provided with a larger range of fiber material options for fracturing, cementing or other downhole applications.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A fiber delivery system comprising:
a packing region having a moving character and to interface fiber material for packing and advancing thereof toward a metering location of the system; and
a corresponding region adjacent the packing region to simultaneously interface the fiber material and having a character that is substantially different from the moving character of the conveyance region.

2. The system of claim 1 wherein the fiber material is one of crimped and between about 15 and about 25 pounds per cubic foot.

3. The system of claim 1 wherein the moving character is provided by a device selected from a group consisting of at least one auger, a conveyor belt and a drag chain.

4. The system of claim 1 wherein the substantially different character of the corresponding region is one of a static character, a vibrating character, a conveyor belt effected character, a drag chain effected character, an auger effected character and a passive moving character.

5. The system of claim 1 further comprising:
a hopper for receiving the fiber material in an unpacked manner in advance of the packing; and
a metering mechanism at the metering location to meter packed fiber material from the regions.

6. The system of claim 5 wherein the metering mechanism comprises a metering auger.

7. The system of claim 5 wherein the regions are incorporated into opposite sidewalls of the hopper and the metering mechanism is positioned below the hopper.

8. The system of claim 7 wherein the opposite sidewalls of the hopper are tapered together toward the metering mechanism therebelow.

9. The system of claim 5 wherein the packing region is located below the hopper and at least partially surrounded by the corresponding region, the metering mechanism located adjacent the regions.

10. The system of claim 9 wherein the hopper comprises substantially non-tapered sidewalls relative the regions therebelow.

11. A fiber management assembly for positioning at an oilfield, the assembly comprising:
a mixer;
a feeder for supplying an application mix to the mixer; and
a fiber delivery system with a metering mechanism to supply packed fiber to the mixer, the system including a packing region of moving character adjacent a corresponding region of a substantially different character for forming the packed fiber from an unpacked form.

12. The fiber management assembly of claim 11 accommodated by a solids delivery unit at the oilfield wherein the mixer is a vortex blender.

13. The fiber management assembly of claim 12 wherein the metering mechanism is one of elongated to reach the vortex blender and interfacing a delivery mechanism to reach the vortex blender.

14. A method of managing fiber at an oilfield with a fiber delivery system, the method comprising:
interfacing a bulk of fiber with a packing region of the system, the packing region having a moving character; and
simultaneously interfacing the bulk of fiber with a corresponding region having a character substantially different from the moving character of the packing region, the interfacing of the bulk of the fiber with each region for packing of the fiber.

15. The method of claim 14 wherein the moving character is provided by a device selected from a group consisting of at least one auger, a conveyor belt and a drag chain.

16. The method of claim 14 wherein a force of between about 5 pounds and about 100 pounds is imparted on the bulk of the fiber during the interfacing with the regions for the packing.

17. The method of claim 14 further comprising:
metering the packed fiber to a mixer;
blending the metered fiber with constituents at the mixer to form a slurry; and
performing an application in a well at the oilfield with the slurry.

18. The method of claim 17 further comprising supplying fiber to the system at a predetermined, substantially constant rate for the interfacing with the regions.

19. The method of claim 18 wherein the rate is between about 5 pounds per minute and about 300 pounds per minute and the application in the well is a fracturing application.

20. The method of claim 18 wherein the rate is between about 1 pound per minute and about 50 pounds per minute and the application in the well is a cementing application.
